(19) United States
(12) Patent Application Publication
(10) Pub. No.: US 2026/0143346 A1
(43) Pub. Date: May 21, 2026

(54) INFORMATION PROCESSING APPARATUS, CONTROL METHOD THEREFOR, STORAGE MEDIUM, AND IMAGE FORMING APPARATUS

(71) Applicant: CANON KABUSHIKI KAISHA, Tokyo (JP)

(72) Inventor: Yuzuru YANO, Ibaraki (JP)

(21) Appl. No.: 19/382,353

(22) Filed: Nov. 7, 2025

(30) Foreign Application Priority Data
Nov. 15, 2024 (JP) 2024-200020

(51) Int. Cl. H04W 12/63; G06F 3/12; H04W 12/06

(52) U.S. Cl. CPC H04W 12/63; G06F 3/1222; G06F 3/1238; G06F 3/1292; H04W 12/06

(57) ABSTRACT

The present disclosure is directed to an information processing apparatus that sets an authentication area for providing a service, comprising: one or more memory devices that store a set of instructions; and one or more processors that execute the set of instructions to: acquire, from a plurality of detection units that are installed at different positions and detect one or more wireless terminals located in a detectable range, spatial position information of the one or more wireless terminals detected, and set the authentication area using the spatial position information relating to one wireless terminal acquired from each detection unit and information of an installation position of each one of the plurality of detection units.

### BACKGROUND

### Field of the Technology

The present disclosure relates to an information processing apparatus, a control method therefor, a storage medium, and an image forming apparatus.

### Description Of The Related Art

A configuration of a known image forming apparatus that provides a different service for each user has been proposed. For example, as proposed in Japanese Patent Laid-Open No. 2024-65644, when a wireless terminal is brought close to a wireless interface provided in an image forming apparatus, user information recorded in the wireless terminal is read and a service suited to the user is provided.

Also, in the configuration proposed in Japanese Patent Laid-Open No. 2020-201837, a wireless terminal inside a predetermined spatial region (hereinafter referred to as an authentication area) is detected, and user information is read from the detected wireless terminal. Typically, an authentication area is a relatively large region of several tens of centimeters. Thus, an image forming apparatus can read the user information from the wireless terminal by a user entering the authentication area while holding a bag storing the wireless terminal. Also, in the configuration proposed in Japanese Patent Laid-Open No. 2023-178059, a plurality of spatial positions are recorded using a position measurement device configured to measure position in a space and a spatial region is defined based on the recorded plurality of spatial positions. For example, eight spatial positions are recorded using the position measurement device, and the inside of a quadrangular prism with the eight positions as vertices is set as an authentication area. In this manner, providing a service can be performed for a device (user) located in a predetermined area.

However, the known technology described above has the following problems. For example, with a method in which a wireless terminal is brought close to a wireless communication interface for providing a service, typically, a communication standard compliant with Near Field Communication (NFC) is used as the wireless communication interface. Thus, with a known image forming apparatus, in order to read the user information, the wireless terminal needs to be brought within a distance of approximately 2 cm or less from the wireless interface. However, the known technology described above has a problem in that the action of bringing the wireless terminal close to the wireless interface is troublesome.

Also, in the case of a system for setting the authentication area, the setting process is complicated. For example, when setting the inside of a quadrangular prism with 8 points as vertices as the authentication area, a corresponding number of position measurement devices are required when simultaneously setting each point, and a member or the like is required for supporting these devices in the air. Also, in the case of setting each point in order one at a time, the measurement time for performing measurement in order using one position measurement device increases, and furthermore, since only one position can be simultaneously confirmed, confirmation of the entire authentication area is difficult, making the setting process complicated.

### SUMMARY

The present technique enables realization of a mechanism for suitably setting a predetermined spatial region and providing a service.

One aspect of the present disclosure provides an information processing apparatus that sets an authentication area for providing a service, comprising: one or more memory devices that store a set of instructions; and one or more processors that execute the set of instructions to: acquire, from a plurality of detection units that are installed at different positions and detect one or more wireless terminals located in a detectable range, spatial position information of the one or more wireless terminals detected, and set the authentication area using the spatial position information relating to one wireless terminal acquired from each detection unit and information of an installation position of each one of the plurality of detection units.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is an overhead view of an image forming system 1 in entirety according to an embodiment.

FIG. 2 is a block diagram of the image forming system 1 in entirety according to an embodiment.

FIG. 3 is a block diagram of the image forming apparatus 101 and its surroundings according to an embodiment.

FIG. 4 is an operation flowchart of a CPU 204 according to an embodiment.

FIG. 5 is a diagram illustrating an example of a screen prompting for user input displayed on an operation unit 202 according to an embodiment.

FIG. 6 is a timing chart illustrating reception timing of user IDs according to an embodiment.

FIG. 7 is a diagram illustrating an example of a screen of user names displayed on the operation unit 202 according to an embodiment.

FIG. 8 is a diagram illustrating an example of print job data stored in a storage 201 according to an embodiment.

FIG. 9 is a diagram illustrating an example of print job data acquired to be displayed on the operation unit 202 according to an embodiment.

FIG. 10 is a block diagram of a determination unit 102 and its surroundings according to an embodiment.

FIG. 11 is an operation flowchart of a CPU 304 according to an embodiment.

FIG. 12 is a diagram illustrating an example of a setting start button of an authentication area 110 displayed on the operation unit 202 according to an embodiment.

FIG. 13 is an operation flowchart of the CPU 304 for S604 according to an embodiment.

FIG. 14 is a diagram illustrating an example of an input screen for a reference tag and authentication area parameters displayed on the operation unit 302 according to an embodiment.

FIG. 15 is a diagram illustrating the relationship between vertices K1 to K8, spatial coordinates TP of the reference tag, and the authentication area parameters according to an embodiment.

FIG. 16 is a diagram illustrating the authentication area 110 in an overhead view of the image forming system 1 in entirety according to an embodiment.

FIG. 17 is an operation flowchart of the CPU 304 for S605 according to an embodiment.

FIG. 18 is a diagram illustrating an example of an input screen for a reference tag and authentication area parameters displayed on the operation unit 302 according to an embodiment.

FIG. 19 is a diagram illustrating the relationship between the spatial coordinates TP of the reference tag and the authentication area parameters according to an embodiment.

FIG. 20 is a diagram illustrating an example of an input screen for an apparatus tag, the reference tag, and the authentication area parameters displayed on the operation unit 302 according to an embodiment.

FIG. 21 illustrates the position of the authentication area 110 after the image forming apparatus 101 is moved or rotated according to an embodiment.

FIG. 22 is an overhead view of the image forming system 1 in entirety when anchors 103A to 103D and the determination unit 102 is disposed inside the image forming apparatus 101 according to an embodiment.

FIG. 23 is a block diagram of the image forming system 1 in entirety when the anchors 103A to 103D and the determination unit 102 is disposed inside the image forming apparatus 101 according to an embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### System Operation Image

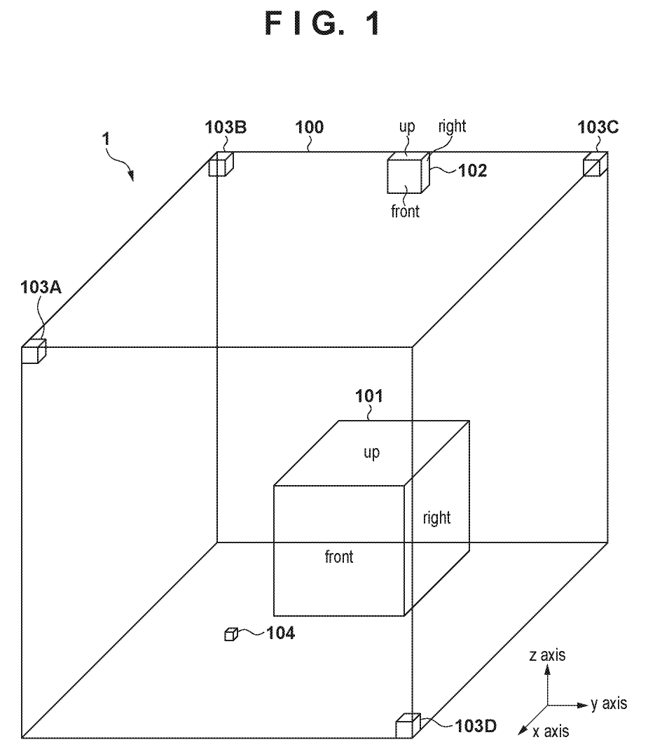

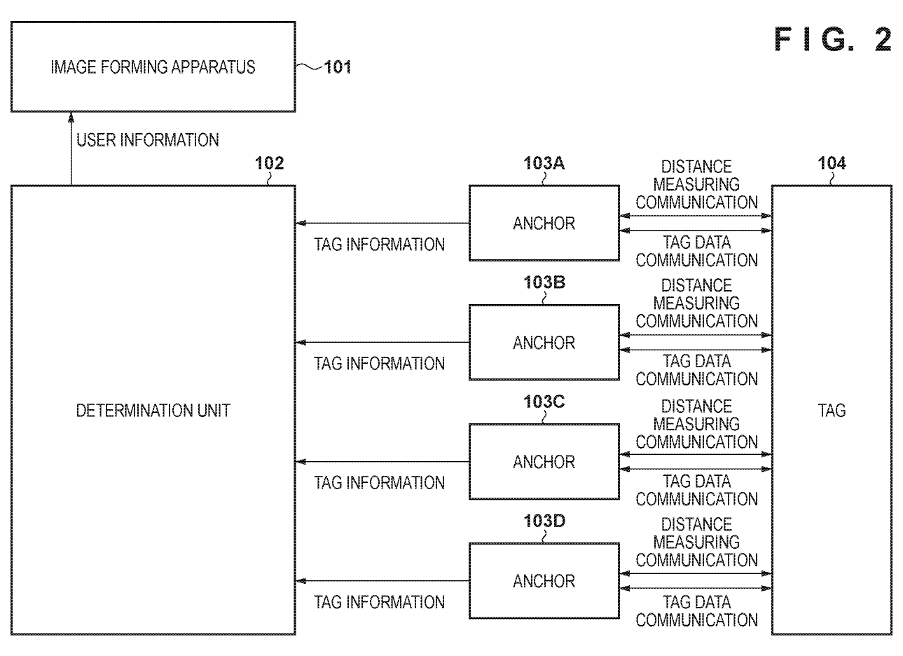

An embodiment of the present disclosure will be described below. An overview of the overall operations of a system 1 according to the present embodiment will now be described with reference to FIGS. 1 and 2. FIG. 1 is an overhead view of the entire image forming system 1 according to the present embodiment. FIG. 2 is a block diagram of the entire image forming system 1 according to the present embodiment.

As illustrated in FIG. 1, the present system 1 includes an image forming apparatus 101, a determination unit 102, anchors 103A to 103D, and a tag 104 inside a predetermined space 100. The image forming apparatus 101 acquires user information from the determination unit 102 and implements an image forming service that is different from each user. For example, an operation menu different for each user is displayed on an operation unit (not illustrated). The operations of the image forming apparatus 101 will be described below in detail.

As illustrated in FIG. 1, according to the present embodiment, as the predetermined space 100, a spatial region with a rectangular parallelepiped shape is set in the proximity of the image forming apparatus 101 providing the service. In the predetermined space 100, the three anchors 103A to 103C are disposed at the vertices of one surface (rectangular parallelepiped upper surface in FIG. 1) from among the upper surface and the bottom surface. Furthermore, the anchor 103D is disposed at a vertex of the other surface (rectangular parallelepiped bottom surface in FIG. 1) corresponding to the vertex where an anchor is not disposed from among the vertices of the first surface. However, no such limitation to the present disclosure is intended, and three anchors may be disposed on the bottom surface and one anchor may be disposed on the upper surface. Alternatively, substituting both side surfaces as the upper surface and the bottom surface, three anchors may be disposed on one side surface and an anchor may be disposed at the vertex of the other side surface corresponding to the vertex where an anchor is not disposed on the first side surface. In other words, in the rectangular parallelepiped spatial region in the proximity of the image forming apparatus 101, three anchors are disposed at vertices of a rectangular parallelepiped predetermined surface and one anchor is disposed at a vertex of a surface, corresponding to the opposite surface of the predetermined surface, corresponding to the vertex where an anchor is not disposed of the vertices of the predetermined surface. In other words, for the four anchors according to the present disclosure, it is sufficient that three anchors are disposed on the predetermined surface and one anchor is disposed on a surface different from the predetermined surface. Note that in the present embodiment, the anchors 103A to 103D are installed in a spatial region external to the image forming apparatus 101, but the anchors 103A to 103D may be provided inside the image forming apparatus 101.

As illustrated in FIG. 2, the determination unit 102 receives information of a tag corresponding to a wireless terminal from the anchors 103A to 103D. The spatial coordinates of the tag is acquired from the received tag information. The determination unit 102 is provided with an authentication area setting mode and a normal operation mode. In the authentication area setting mode, a spatial region is set as an authentication area 110 from the spatial coordinates of the tag and the authentication area parameter input to the determination unit 102. The authentication area parameter can be changed by the user. In the normal operation mode, it is determined whether or not the spatial coordinates of the tag are inside the authentication area 110. In the case of being inside the authentication area 110, the user information included in the tag information is transmitted to the image forming apparatus 101. The operations of the determination unit 102 will be described below in detail.

As the operations of the anchors 103A to 103D are all similar, the operations of the anchor 103A will be described as a representative. The anchor 103A is a device for detecting a tag that exists in a tag detectable range. In FIG. 1, the detected tag is illustrated as the tag 104. The anchor 103A performs distance measuring communication and data communication with the tag 104 compliant with a predetermined protocol. As a result, the distance between the anchor 103A and the tag 104 and the user information stored in the tag 104 is acquired. Then, the acquired distance and user information is transmitted to the determination unit 102 as tag information. In a case where no tag exists in the tag detectable range, that no tag was detected is transmitted to the determination unit 102 as the tag information.

The tag 104 represents a tag that exists in the tag detectable range of the anchors 103A to 103D. The tag 104 is a device that performs distance measuring communication and data communication with the anchors 103A to 103D compliant with a predetermined protocol. As a result, the distance between each anchor 103A to 103D and the tag 104 and the user information stored in the tag 104 is acquired by the anchors 103A to 103D.

The detection operation of the tag 104 by the anchors 103A to 103D will now be described. The anchors 103A to 103D are always detecting tags in the tag detectable range after being turned on. The detection cycle can be set. For example, in the present embodiment, the detection cycle is 100 ms. When a tag is detected, the distance to the detected tag is measured. Also, the user information stored inside the tag is acquired by each anchor. Then, the distance measurement result and the user information are transmitted to the determination unit 102. In a case where a plurality of tags are detected in the tag detectable range, this operation is performed in a similar manner for each tag.

As long as the anchors 103A to 103D has a configuration including a measurement unit for measuring the distance to the tag 104, a data communication unit for communicating with the tag 104, and a data communication unit for communicating with the determination unit 102, any type of device may be used. In a similar manner, as long as the tag 104 has a configuration including a measurement unit for measuring the distance to the anchors 103A to 103D, a data communication unit, and a user information storing unit, any type of device may be used. For example, in the present embodiment, ultra-wideband (UWB) wireless communication devices, known technology, are used as a UWB anchor and a UWB tag. In a case where a UWB anchor and a UWB tag are used, typically, the tag detectable range of the anchor is approximately 30 m and the distance measurement accuracy is approximately 10 cm. Also, the anchors 103A to 103D and the determination unit 102 perform data communication via a wired or wireless local area network (LAN).

Operations of Image Forming Apparatus 101

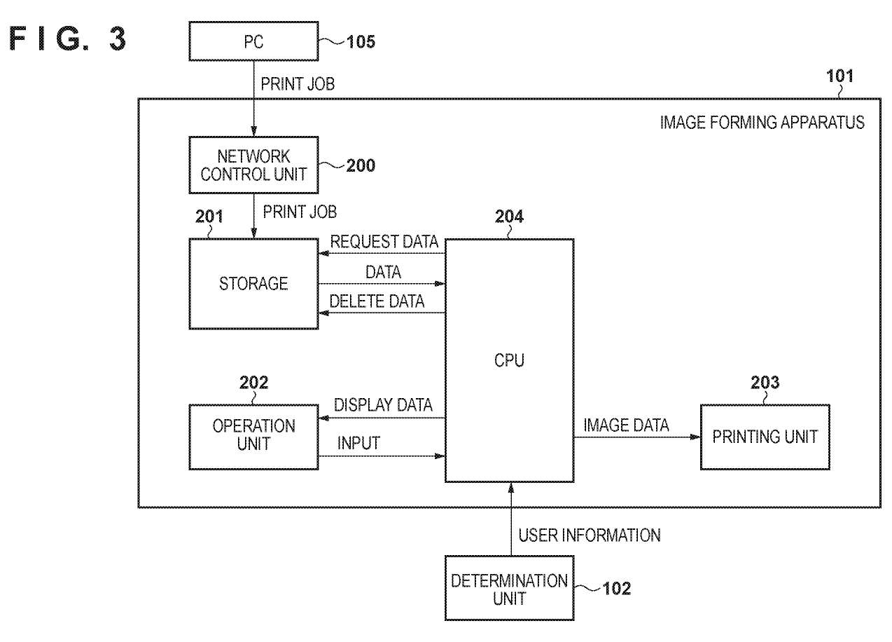

The operations of the image forming apparatus 101 according to the present embodiment will now be described with reference to FIG. 3. FIG. 3 is a block diagram of the image forming apparatus 101 and its surroundings. The image forming apparatus 101 includes a network control unit 200, a storage 201, an operation unit 202, a printing unit 203, and a CPU 204.

The network control unit 200, for example, uses a wired or wireless local area network (LAN) interface. The network control unit 200 stores print job data received from an external PC 105 in the storage 201. The print job data includes the user ID of the user who transmitted the print job, a print image, and print operation settings. The storage 201, for example, uses a hard disk drive (HDD). Also, the storage 201 transmits the stored print job data to the CPU 204 in response to a request from the CPU 204. Furthermore, the storage 201 deletes the print job data in response to a deletion request from the CPU 204.

The operation unit 202, for example, uses a liquid crystal touch panel. The operation unit 202 displays a screen according to display data input from the CPU 204. Also, the input by a user on the touch panel is transmitted to the CPU 204. The printing unit 203 is a control unit for printing image data on a sheet. The printing unit 203, for example, uses a print control unit of a laser beam printer using a known typical electro-photographic method. The printing unit 203 prints an image on a sheet held in a sheet holding unit (not illustrated) according to image data received from the CPU 204. The sheet where an image is printed on is discharged outside of the image forming apparatus 101 so as to be acquired by the user of the image forming apparatus 101.

The CPU 204 performs control of the entire image forming apparatus 101. The CPU 204 requests the storage 201 for print job data and acquires the print job data. Also, in a case where print job data is not required, the CPU 204 performs a print job data deletion request. The CPU 204 transmits, to the operation unit 202, screen display data for communicating information to the user. Also, the CPU 204 receives the content input on the touch panel by the user from the operation unit 202. The CPU 204 receives the user information from the determination unit 102. The user information is used in selecting a print job to be acquired from the storage 201 and the like.

Processing Process of CPU 204

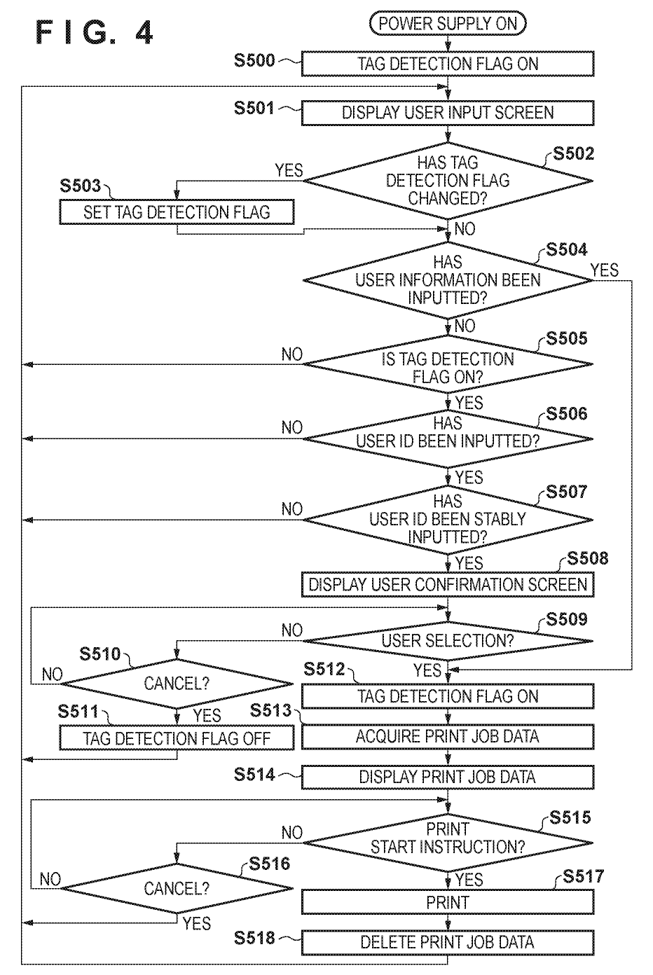

The processing process of the CPU 204 of the image forming apparatus 101 according to the present embodiment will now be described with reference to FIG. 4. The processing described below is implemented by the CPU 204 reading out and executing a control program stored in the storage 201.

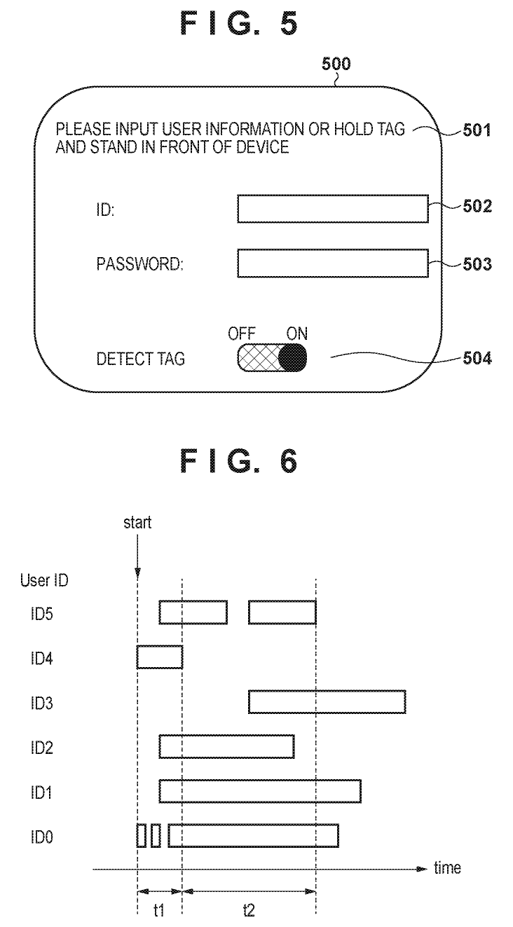

In S500, the CPU 204 sets a tag detection flag to on and starts tag detection. Next, in S501, the CPU 204 transmits display data for prompting for user input to the operation unit 202. An example of the displayed screen is illustrated in FIG. 5. A screen 500 includes a message 501, input areas 502 and 503, and a setting area 504. In the setting area 504, the tag detection flag can be set, and the current on/off state of the tag detection flag is displayed. The state of the tag detection flag of the CPU 204 is displayed. In FIG. 5, the tag detection flag is illustrated in an on state. The message 501 includes a message prompting for the input of user information. Also, the phrase “or hold the tag and stand in front of the device” displayed in the message 501 of FIG. 5 is only displayed when the tag detection flag is on. This is because this is a phrase relating to a function that operates only when the tag detection flag is on. The input area 502 is an area for inputting the user ID, and the input area 503 is an area for inputting a password corresponding to the user ID.

In S502, the CPU 204 determines whether or not the user has changed the tag detection flag via the operation unit 202. In the case of a change, the process advances to S503. In the case of no change, the process advances to S504. In S503, the CPU 204 sets the tag detection flag according to the user operation of the operation unit 202.

In S504, the CPU 204 determines whether or not user information has been input from the operation unit 202. In a case where user information has been input, the process advances to S512. In a case where user information has not been input, the process advances to S505. Note that an example of the user information input method may include providing the image forming apparatus 101 with an interface supporting a communication standard compliant with Near Field Communication (NFC) and bringing the ID card storing the user information close to it.

In S505, the CPU 204 determines whether or not the tag detection flag is on. In the case of on, the process advances to S506. In the case of off, the process advances to S501. In S506, the CPU 204 determines whether or not a user ID is included in the user information received from the determination unit 102. In a case where the user ID is included, the process advances to S507. In a case where the user ID is not included, that is, user unknown information has been received, the process advances to S501.

In S507, the CPU 204 determines whether or not the user ID from the determination unit 102 has been stably input. In a case where the user ID has been stably input, authentication via the tag is determined to be successful and the process advances to S508. Otherwise, the process advances to S501.

The method for determining whether or not the user ID has been stably input will now be described. In a case where a user ID exists that has been continuously received from the determination unit 102 in a time period of a predetermined amount of time t2 after a predetermined amount of time t1 has passed, it is determined that the user ID has been stably input. An example will be described below. FIG. 6 is a timing chart illustrating a receiving timing of user IDs. The horizontal axis represents time. The timing indicated by start is the timing at which the processing of S507 is started. The reception timing of a user ID included in the user information received from the determination unit 102 is indicated by a rectangle. Since the user information includes a plurality of user IDs, the reception timings of a plurality of user IDs are indicated. For example, user ID4 is indicated as being included in the user information for the predetermined amount of time t1 from the processing start of S507. In a case where a user ID exists that has been continuously received in a time period of the predetermined amount of time t2 after the predetermined amount of time t1 has passed, it is determined that the user ID has been stably input. In the example of FIG. 6, ID0 and ID1 are determined to be user IDs that have been stably input. Also, the user ID determined to have been stably input and the user name associated with the user ID are stored in the memory (not illustrated). Note that in FIG. 6, the reception timings for ID0 to ID5 are illustrated, but other IDs may be included in the user information received from the determination unit 102. Even in a case where IDs other than the ID0 to ID5 are included in the user information, processing similar to that described above is executed.

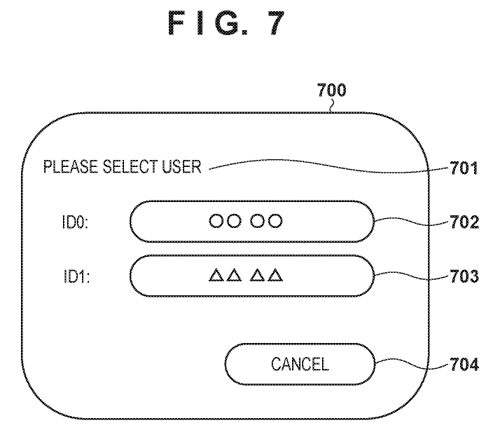

In S508, the CPU 204 displays the user ID and the user name stored in S507 on the operation unit 202. The identification information of the user displayed here indicates a user with successful authentication via a tag and that provision of the image forming service provided by the image forming apparatus 101 is permitted. In a case where a plurality of user IDs are stored, they are displayed as a list. FIG. 7 illustrates an example of a screen displayed on the operation unit 202. A screen 700 includes a message 701, selection areas 702 and 703, and a cancel button 704. The message 701 displays a message prompting the user to make a selection. In the example of FIG. 7, in the selection areas 702 and 703, the user names of ID0 and ID1 are displayed in a list in a selectable manner. The user checks the screen and selects their own user name. When the cancel button 704 is operated, the selection of the selection areas 702 and 703 are cancelled, and the screen returns to the screen before the transition.

In S509, the CPU 204 determines whether or not a user selection has been made. In a case where a user selection operation has been input from the operation unit 202, the selected user ID is stored in the memory (not illustrated), then the process advances to S512. Otherwise, the process advances to S510. In S510, the CPU 204 determines whether or not the cancel button has been pushed from the operation unit 202. In a case where the cancel button has been pushed, the process advances to S511. Otherwise, the process advances to S509.

In S511, the CPU 204 sets the tag detection flag to off and returns the processing to S501. The reason is explained below. S511 is executed in a case where an appropriate candidate is not found for the user of the image forming apparatus 101 among the user names displayed on the operation unit 202 on the basis of the user information from the determination unit 102. Thus, there is a high possibility that the user of the image forming apparatus 101 will input user information in S504. In a case where the tag detection flag is on and the user ID is stably input from the determination unit 102, the screen displayed on the operation unit 202 in S501 is updated in S508. If the screen is updated while the user information is being input from the operation unit 202, this operation would cause the user to be inconvenienced. So that such an operation is not caused, the tag detection flag is temporarily set to off. When the tag detection flag is set to off, via the determination of S505, the screen displayed on the operation unit 202 in S501 cannot produce an update operation in S508.

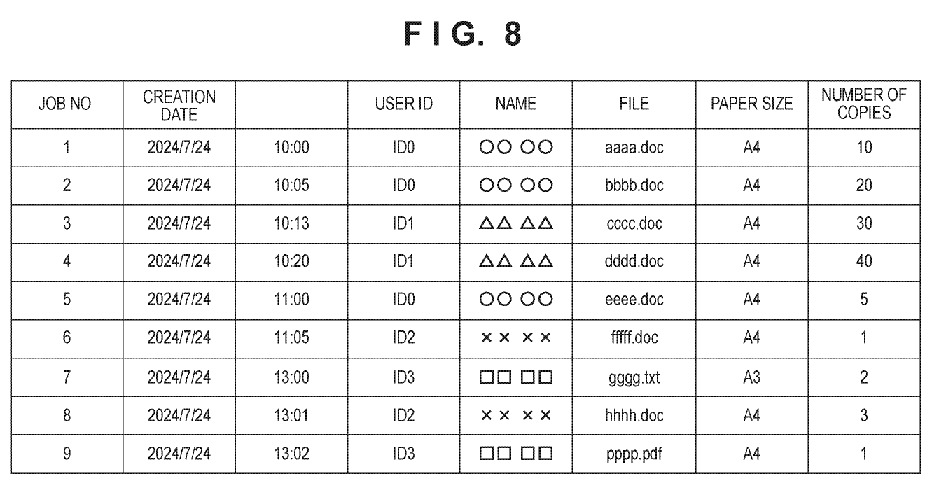

On the other hand, in S512, the CPU 204 sets the tag detection flag to on. In a case where the operation mode is temporarily set to a mode that does not use the user information input from the determination unit 102, the goal is to return the operation mode to a mode that uses the user information from the determination unit 102. Next, in S513, the CPU 204 acquires print job data corresponding to the user ID stored in S509 from the storage 201. FIG. 8 illustrates an example of print job data stored in the storage 201. For each print job, a JOB No is allocated as a serial number and the job transmission date and time, user ID, user name, print file name, paper size, and number of copies to print are stored. For example, for the stored data of FIG. 8, in the case of acquiring the print job data of user ID0, the print job data of JOB No. 1, JOB No. 2, and JOB No. 5 is acquired.

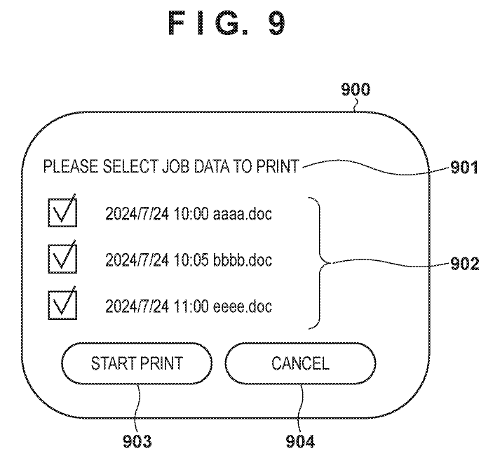

In S514, the CPU 204 displays the information of the print job data acquired in S513 as described above on the operation unit 202. In a case where a plurality of print jobs are acquired, a list is displayed. FIG. 9 illustrates an example of a screen displayed on the operation unit 202. A screen 900 includes a message 901, a selection area 902, a print start button 903, and a cancel button 904. The message 901 displays a message prompting for selection of a job to print. In the selection area 902, the job transmission date and time and the file name of the one or more print job acquired are displayed in a selectable manner. In the selection area 902, a checkbox is displayed in a selectable manner for each print job. The user looks at the screen and selects the print job for printing via the checkbox. When the print start button 903 is operated, printing of the selected print job is started. When the cancel button 904 is operated, the screen returns to the screen before the transition without printing being started.

In S515, the CPU 204 determines whether or not a print start instruction has been issued from the operation unit 202. In a case where a print start instruction has been issued while one or more print jobs have been selected, the selected print job is stored in the memory (not illustrated) and the process advances to S517. Otherwise, the process advances to S516. For example, in order to issue a print start instruction on the screen 900, at least one print job needs to be selected via a checkbox of the selection area 902 and the print start button 903 needs to be operated via being pressed. In S516, the CPU 204 determines whether or not the user has selected to cancel. In a case where the cancel button 904 has been operated from the operation unit 202, the process advances to S501. Otherwise, the process advances to S515.

On the other hand, in S517, the CPU 204 transmits image data based on the print job selected in S515 to the printing unit 203. The printing unit 203 prints an image on a sheet held in the sheet holding unit (not illustrated) according to the received image data. The sheet printed on is output outside of the image forming apparatus 101. Next, in S518, the CPU 204 deletes print jobs that are not required from the storage 201. For example, in a case where printing is executed of the print jobs JOB No. 1, JOB No. 2, and JOB No. 5 in S517 described above, a deletion request for these print jobs is sent to the storage 201, and the processing returns to S501.

Operations of Determination Unit 102

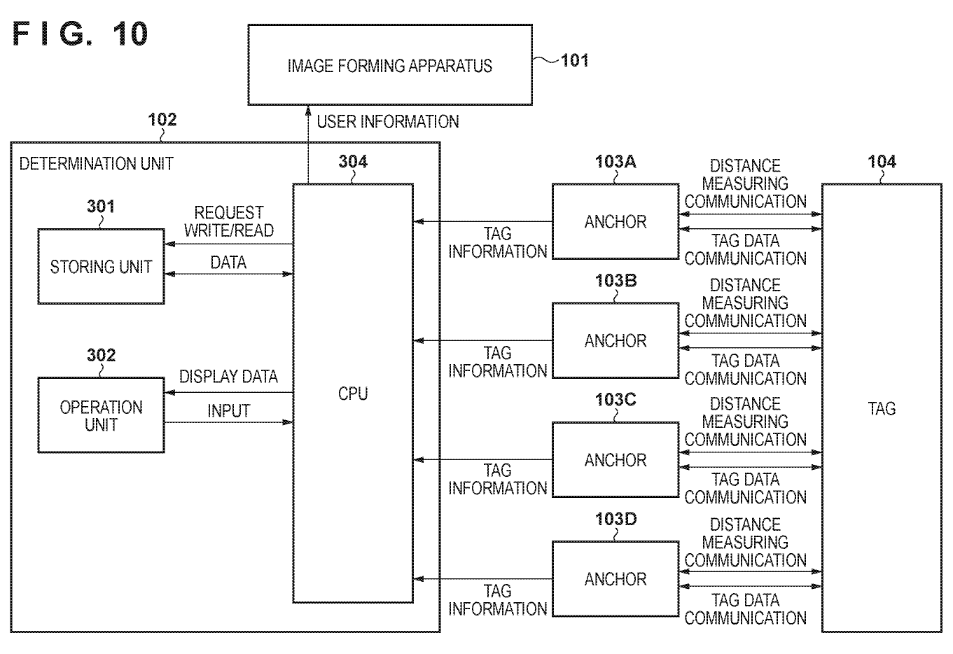

The operations of the determination unit 102 according to the present embodiment will now be described with reference to FIG. 10. FIG. 10 illustrates a block diagram of the determination unit 102 and its surroundings. The determination unit 102 includes a storing unit 301, an operation unit 302, and a CPU 304. The storing unit 301, for example, uses a hard disk drive (HDD). The storing unit 301 writes data in response to a write request from the CPU 304. Also, the storing unit 301 transmits stored data to the CPU 304 in response to a read request from the CPU 304. The storing unit 301 stores authentication area information and the spatial coordinates of the anchors 103A to 103D.

The operation unit 302, for example, uses a liquid crystal touch panel. The operation unit 302 displays various types of screens according to display data input from the CPU 304. Also, the operation unit 302 transmits input by a user on the touch panel to the CPU 304. The CPU 304 controls the entire determination unit 102. The CPU 304 reads and writes data to and from the storing unit 301. The CPU 304 transmits, to the operation unit 302, screen display data for communicating information to the user. Also, the CPU 304 receives inputs by a user on the touch panel and receives tag information from the anchors 103A to 103D. The CPU 304 transmits user information acquired from the tag information to the image forming apparatus 101.

The spatial coordinates of the anchors 103A to 103D stored in the storing unit 301 will now be described. The spatial coordinates of the anchors 103A to 103D are input by the user after installation of the anchors 103A to 103D. The input values are stored in the storing unit 301. The spatial coordinates of the anchors 103A to 103D are acquired by the user measuring the distance in the XYZ axis directions with respect to a reference point of the spatial coordinates with a tape measure or the like. The reference point of the spatial coordinates may be any place. For example, in the present embodiment, the position of the anchor 103A is set as the reference point of the spatial coordinates. Also, the XYZ axis directions can also be defined at the discretion of the user. For example, in the present embodiment, the direction from the back to the front of FIG. 1 is set as the X-axis direction, the direction from left to right is set as the Y-axis direction, and the direction from down to up is set as the Z-axis direction. Note that the input of the spatial coordinates of the anchors 103A to 103D only needs to be performed once after installation. However, in a case where the anchors 103A to 103D are moved, they need to be input again.

Here, the spatial coordinates of each anchor stored in the storing unit 301 are spatial coordinates AP: (AX, AY, AZ) for the anchor 103A, spatial coordinates BP: (BX, BY, BZ) for the anchor 103B, spatial coordinates CP: (CX, CY, CZ) for the anchor 103C, and spatial coordinates DP: (DX, DY, DZ) for the anchor 103D. For example, the x component of the spatial coordinates of AP is AX, the y component is AY, and the z component is AZ. The values of AX, AY, AZ, BX, BY, BZ, CX, CY, CZ, DX, DY, and DZ are values measured by the user. Note that the spatial coordinates of each anchor indicate the spatial coordinates of the center of each anchor.

Processing Process of CPU 304

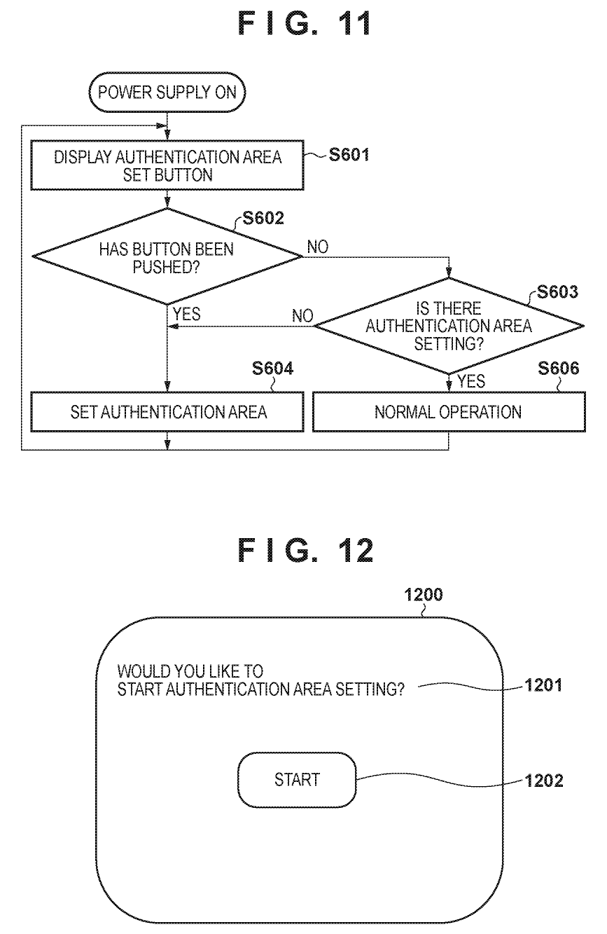

The processing process of the CPU 304 of the determination unit 102 according to the present embodiment will now be described with reference to FIG. 11. The processing described below is implemented by the CPU 304 reading out and executing a control program stored in the storing unit 301, for example.

In S601, the CPU 304 displays a button for starting the setting of the authentication area 110 on the operation unit 302. FIG. 12 illustrates an example of a display screen displayed on the operation unit 302. A screen 1200 includes a message 1201 and a start button 1202. The message 1201 displays a message prompting for the start of setting area. To set the spatial region of the authentication area 110, the user operates the start button 1202. Note that the screen 1200 may be displayed on the operation unit 202 of the image forming apparatus 101. In this case, the information input via the screen is transmitted to the determination unit 102 from the image forming apparatus 101. Note that the screen displayed on the operation unit 302 described below may also be displayed on the operation unit 202 of the image forming apparatus 101.

In S602, the CPU 304 determines whether or not the start button 1202 displayed on the operation unit 302 has been operated by the user. In a case where it has been operated, the process advances to S604 to perform operations with the operation mode in the authentication area setting mode (update mode). Otherwise, the process advances to S603 to perform operations with the mode in the normal operation mode (maintain mode).

In S603, the CPU 304 determines whether or not a setting of the authentication area 110 is stored in the storing unit 301. In a case where a setting of the authentication area 110 is stored in the storing unit 301, the process advances to S605. Otherwise, the process advances to S604 to perform operations with the mode in the authentication area setting mode. Note that in the initial state of the determination unit 102, a setting of the authentication area 110 is not stored in the storing unit 301. In S707 described below, by storing the authentication area 110, the setting of the authentication area 110 is put in a state of being stored in the storing unit 301.

In S604, the CPU 304 performs setting of the authentication area 110 and returns the processing to S601. The processing will be described below in detail. On the other hand, in S605, the CPU 304 performs normal operations and returns the processing to S601. The processing will be described below in detail.

Setting an Authentication Area

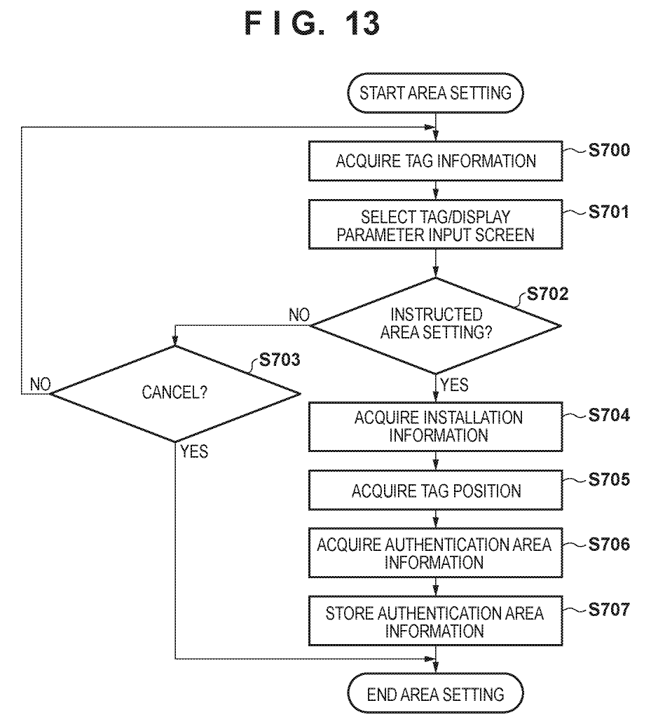

The processing process in setting a spatial region of the authentication area 110 of S604 (update mode) will now be described with reference to FIG. 13. The processing described below is implemented by the CPU 304 reading out and executing a control program stored in the storing unit 301, for example.

In S700, the CPU 304 receives tag information from the anchors 103A to 103D. The tag information includes information of the distance to the tags detected by each of the anchors 103A to 103D and the user ID and user name stored inside the detect tags. In a case where each anchor detects a plurality of tags, information relating to all of the tags is included in the tag information. In a case where an anchor does not detect any tags, it receives information indicating that not tags were detected.

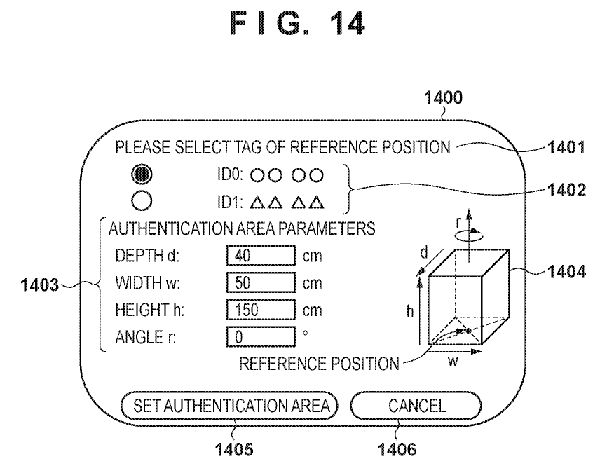

Next, in S701, the CPU 304 displays a candidate list for a tag (hereinafter referred to as a reference tag) that is a wireless terminal to be the reference position for setting the authentication area 110 and an authentication area parameter input field on the operation unit 302. The user inputs a value for the reference tag and the authentication area parameter from the operation unit 302. The input values are stored in the memory (not illustrated). FIG. 14 illustrates an example of a display screen displayed on the operation unit 302. A screen 1400 includes a message 1401, a selection area 1402, a parameter 1403, a legend 1404, a set button 1405, and a cancel button 1406. The message 1401 displays a message prompting for selection of a tag to be the reference position. In the selection area 1402, as candidates for the reference tag, the user IDs and the user names are displayed as a list in a selectable manner. The user selects the reference tag via a radio button. For the candidates for the reference tag, only those relating to a user ID included in the all of the tag information from the anchors 103A to 103D are displayed. The reference tag candidates will now be described. For example, take an example in which the user IDs included in the tag information from each anchor are as follows.

Anchor 103A: ID0, ID1, ID2

Anchor 103B: ID0, ID1, ID2

Anchor 103C: ID0, ID1

Anchor 103D: ID0, ID1, ID3

User IDs confirmed from all of the tag information of the anchors 103A to 103D: ID0, ID1.

Thus, the reference tag candidates are ID0 and ID1. In a case where there are no reference tag candidates, no reference tag candidates are displayed. The parameter 1403 is an authentication area parameter, and various items relating to the shape of the authentication area 110 may be considered. For example, in the present embodiment, as the authentication area parameters, depth d, width w, height h, and angle r are settable in the display. In the legend 1404, a schematic view of an authentication area for explaining each parameter of the authentication area parameters is displayed, and in this example, it is a rectangular prism. When the set button 1405 is operated, setting of the authentication area is performed using the contents set as in the parameter 1403 and the like. When the cancel button 1406 is operated, the screen returns to the screen before the transition without setting the authentication area.

In S702, the CPU 304 determines whether or not an authentication area setting instruction has been issued. In a case where an authentication area setting instruction has been issued, the process advances to S704. Otherwise, the process advances to S703. In the present embodiment, to issue an authentication area setting instruction, the set button 1405 needs to be operated after the operation unit 302 is used, the reference tag is selected in the selection area 1402, and the authentication area parameters are input in the parameter 1403. The CPU 304 receives the selection information of the selected reference tag and the input parameters relating to the authentication area. In S703, the CPU 304 determines whether or not the cancel button 1406 has been operated. In a case where the cancel button 1406 has been operated, the authentication area setting ends, and the processing of the present flowchart ends. Otherwise, the processing returns to S700.

On the other hand, in S704, the CPU 304 acquires the spatial coordinates (installation position) of the anchors 103A to 103D as installation information from the storing unit 301. The spatial coordinates of the anchors 103A to 103D are stored in advance after the installation of the anchors 103A to 103D. Next, in S705, the CPU 304 acquires the spatial coordinates of the reference tag selected by the user in S702. For example, in the present embodiment, a case in which ID0 is selected as the reference tag will now be described. In this example, the tag holding the user information of ID0 is the tag 104. The distance from the anchors 103A to 103D to the tag 104 is received as tag information (spatial position information). The spatial coordinates (spatial position) of the tag 104 is acquired from the received distance information. It is widely known that, in a case where the distance from four points with known spatial coordinates not on the same plane to one point with unknown spatial coordinates is clear via a known mathematical method, computation of the spatial coordinates of the unknown one point is possible.

An outline of the acquiring method will now be described. The distance (spatial position information) between the anchor 103A and the tag 104 is set as AL, the distance between the anchor 103B and the tag 104 is set as BL, the distance between the anchor 103C and the tag 104 is set as CL, and the distance between the anchor 103D and the tag 104 is set as DL. Here, the spatial coordinates of the tag 104 are acquired as intersection points of a sphere with a radius AL centered on the anchor 103A, a sphere with a radius BL centered on the anchor 103B, a sphere with a radius CL centered on the anchor 103C, and a sphere with a radius DL centered on the anchor 103D. The XYZ direction components of the acquired spatial coordinates of the tag 104 are set as spatial coordinates TP (TX, TY, TZ) of the tag 104. Since the spatial coordinates (installation position) of the anchors 103A to 103D and the distance (spatial position information) from the anchors 103A to 103D to the tag 104 are known, the values of TX, TY, and TZ are values known from the computation described above.

In S706, the CPU 304 acquires the authentication area information. For example, in the example of the present embodiment described here, as the authentication area parameters, depth d: 40 cm, width w: 50 cm, height h: 150 cm, and angle r: 0° are input. The authentication area parameters may be considered as various items relating to the shape of the authentication area 110. Note that in the present embodiment described here, the authentication area parameters are acquired via user input. However, the present disclosure is not limited thereto, and predetermined parameters (default values) may be used. Also, the default values may be display in a changeable manner. In this case, the default values are displayed in a changeable manner on the screen 1400.

For example, in the method according to present embodiment described here, the authentication area 110 is a rectangular prism, and the spatial coordinates of the eight vertices of the rectangular prism are acquired using the authentication area parameters on the basis of the spatial coordinates of the tag 104. The depth d is the x-direction component value, the width w is the y-direction component value, and the height h is the z-direction component value. Thus, for the spatial coordinates of vertices M1 to M8 of the rectangular prism, the spatial coordinates of the vertex M1 are (TX + d/2, TY - w/2, TZ), the spatial coordinates of the vertex M2 are (TX - d/2, TY - w/2, TZ), the spatial coordinates of the vertex M3 are (TX + d/2, TY + w/2, TZ), the spatial coordinates of the vertex M4 are (TX - d/2, TY + w/2, TZ), the spatial coordinates of the vertex M5 are (TX + d/2, TY - w/2, TZ + h), the spatial coordinates of the vertex M6 are (TX - d/2, TY - w/2, TZ + h), the spatial coordinates of the vertex M7 are (TX + d/2, TY + w/2, TZ + h), and the spatial coordinates of the vertex M8 are (TX - d/2, TY + w/2, TZ + h). Here, since TX, TY, TZ, d, w, and h are known values, the spatial coordinates of the vertices M1 to M8 are also known.

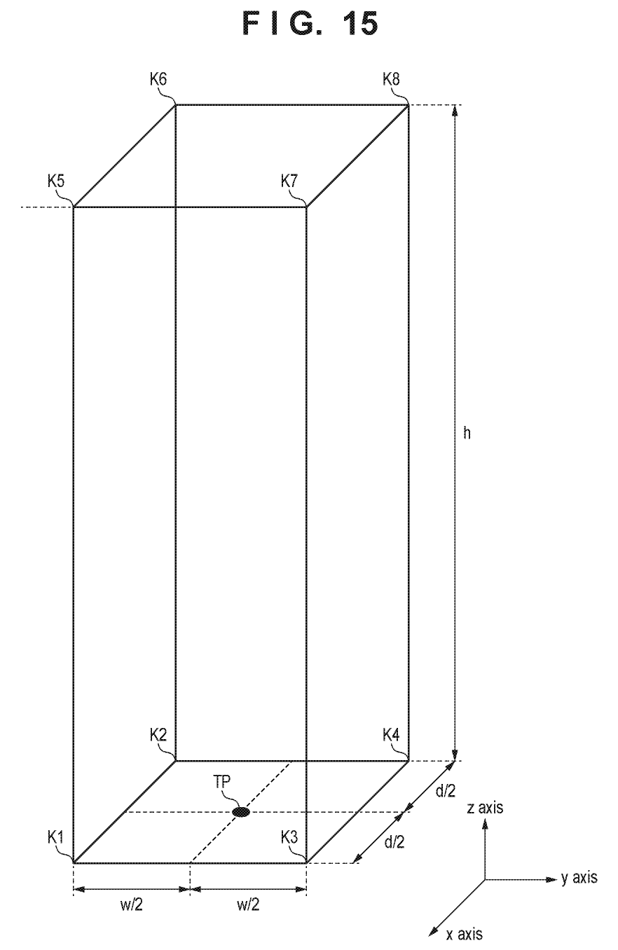

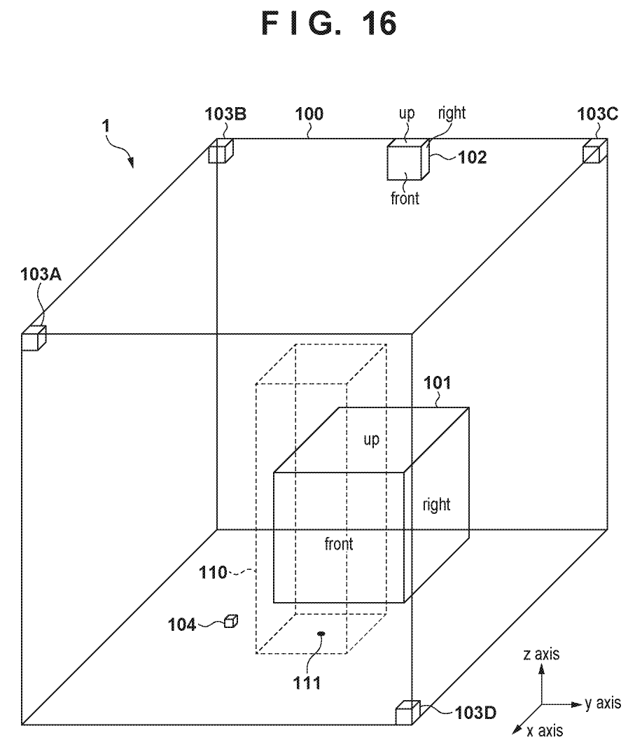

Also, the vertices M1 to M8 are rotated the angle r about a line parallel with the Z-axis direction running through the spatial coordinates TP of the tag 104. The points after the rotation of the vertices M1 to M8 correspond to K1 to K8. The inside of the rectangular prism formed with the eight points K1 to K8 as the vertices corresponds to the authentication area 110. It is widely known that the spatial coordinates of a point acquired by rotating any point any angle about any line can be acquired via a known mathematical method. Thus, the details will not be described. In the present embodiment, the angle r is 0°. Thus, the vertices M1 to M8 and K1 to K8 are the same spatial coordinates. FIG. 15 is a diagram illustrating the relationship between the vertices K1 to K8, the spatial coordinates TP of the tag 104, and the authentication parameters.

In S707, the CPU 304 stores the coordinates of the vertices K1 to K8 in the storing unit 301 as the authentication area information. After the authentication area information is stored, the reference tag is no longer required. In other words, from S707 onward, moving the tag 104 does not affect the setting of the authentication area 110. FIG. 16 is a diagram illustrating the authentication area 110 in an overhead view of the entire image forming system 1. The rectangular prism indicated by the broken lines is the authentication area 110. Point 111 indicates the place where the reference tag was disposed when the authentication area 110 was set.

### Normal Operation

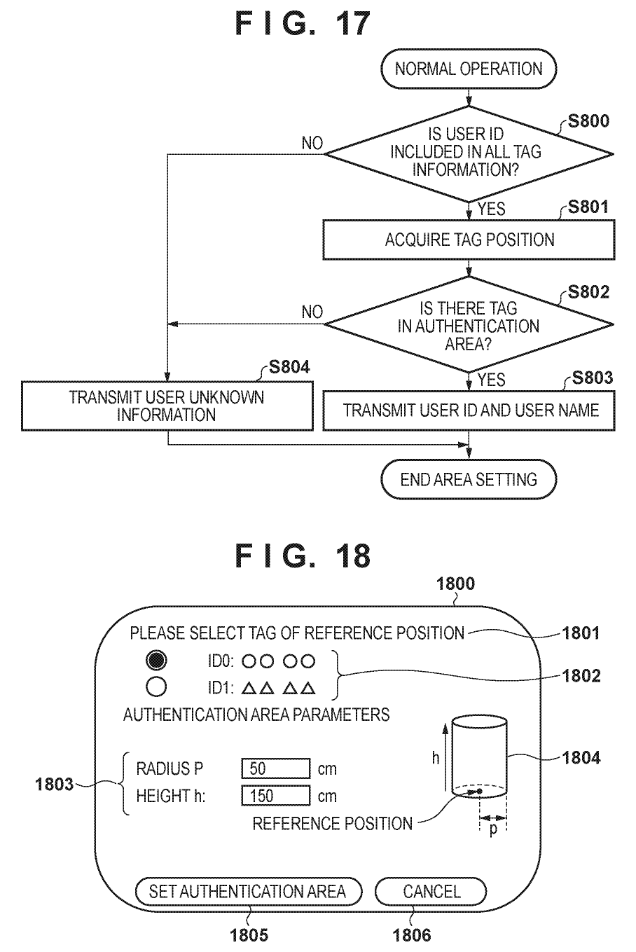

The processing process of the normal operation of S605 (maintain mode) will now be described in detail with reference to FIG. 17. The processing described below is implemented by the CPU 304 reading out and executing a control program stored in the storing unit 301, for example.

In S800, the CPU 304 determines whether a user ID exists that is included in the tag information from all of the anchors 103A to 103D. In a case where one exists, the process advances to S801. Otherwise, the process advances to S804. A detail determination method will be described below. The tag information received from each anchor includes a user ID stored in the detected tag. For example, take an example in which the user IDs included in the tag information from each anchor are as follows.

Anchor 103A: ID0, ID1, ID2

Anchor 103B: ID0, ID1, ID2

Anchor 103C: ID0, ID1

Anchor 103D: ID0, ID1, ID3

User IDs confirmed from all of the tag information of the anchors 103A to 103D: ID0, ID1.

Accordingly, the CPU 304 determines that a user ID exists that is included in the tag information from all of the anchors 103A to 103D. Also, the CPU 304 stores the user ID included in the tag information from all of the anchors 103A to 103D in the memory (not illustrated).

Next, in S801, the CPU 304 acquires the spatial coordinates of the tag (hereinafter referred to as the detected tag) storing the user ID information included in the tag information from all of the anchors 103A to 103D. In a case where there are a plurality of detected tags, the CPU 304 acquires this for all of the detected tags. The CPU 304 stores the acquired results in the memory (not illustrated). The method for acquiring the spatial coordinates is similar to that of S705 described above.

In S802, the CPU 304 determines whether or not a detected tag exists in the authentication area 110. In a case where a plurality of detected tags exist, the determination is performed for all of the detected tags. In a case where at least one or more detected tags exist in the authentication area 110, the process advances to S803. Otherwise, the process advances to S804. A method for determining whether or not any point exists in a predetermined spatial region via a known mathematical method is widely known. Thus, a detailed acquiring method for determining whether or not a detected tag exists in the authentication area 110 will not be described. The information of the authentication area 110 is stored in the storing unit 301 in S707 as described above. The shape of the authentication area 110 may be one of various plausible shapes. However, in the present embodiment, the spatial coordinates of eight points are stored in the storing unit 301, and the authentication area 110 corresponds to the inside of a rectangular prism formed by the vertices corresponding to these eight points.

In S803, the CPU 304 determines that authentication via a tag is successful, transmits the user information to the image forming apparatus 101 to allow the service to be provided, and ends the processing of the present flowchart. Specifically, the user ID and the user name stored in the detected tag existing in the authentication area 110 are transmitted by the CPU 304. In a case where there are a plurality of target tags existing, the CPU 304 transmit information for all of the tags corresponding to targets.

On the other hand, in S804, the CPU 304 transmits the user information to the image forming apparatus 101 and ends the processing of the present flowchart. Specifically, the CPU 304 transmits user unknown information.

As described above, the information processing apparatus (determination unit 102) according to the present embodiment is an information processing apparatus that sets an authentication area for providing a service. The present information processing apparatus acquires the spatial position information of one or more detected wireless terminals from a plurality of anchors installed at different positions that are configured to detect one or more wireless terminals located in a detectable range. Also, the present information processing apparatus sets an authentication area using the spatial position information relating to one wireless terminal acquired from each anchor and information of the installation position of each of the plurality of anchors. Also, the information processing apparatus according to the present embodiment receives selection information for selection of a wireless terminal to be used in setting the authentication area from the one or more wireless terminals and parameters relating to the authentication area such as depth, width, height, and rotation angle. Also, the present information processing apparatus sets the authentication area on the basis of the spatial position of the wireless terminal corresponding to the selection information according to the received parameters. Accordingly, with the image forming system 1 that determines whether or not a tag, which is a wireless communication device terminal, exists inside the authentication area 110, which is a predetermined spatial region, setting of the spatial region of the authentication area 110 can be easily performed. In other words, according to the present disclosure, a mechanism for suitably setting a predetermined spatial region and providing a service can be provided.

### Second Embodiment

The second embodiment of the present disclosure will be described below. The present embodiment has a goal of reducing the number of authentication parameter items in S701 of the first embodiment described above. In the first embodiment described above, the authentication area 110 is a rectangular prism. However, in the present embodiment, the authentication area 110 is a cylinder. As a result, the number of authentication area parameter items can be reduced. In the present embodiment, mainly the configurations and controls that are different from the first embodiment will be described. In particular, parts that are different in the processing process of CPU 304 will be described below.

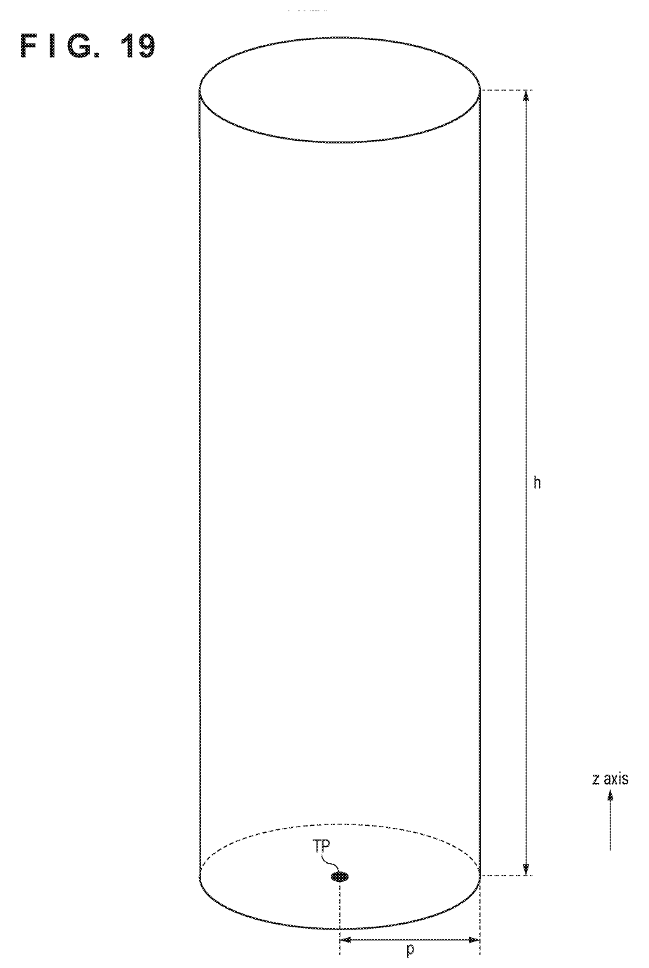

Parts that are different from the first embodiment described above in the flowchart of FIG. 13 will mainly be described. FIG. 18 illustrates a screen displayed on the operation unit 302 in S701 described above in the present embodiment. A screen 1800 includes a message 1801, a selection area 1802, a parameter 1803, a legend 1804, a set button 1805, and a cancel button 1806. The message 1801 displays a message prompting for selection of a tag of the reference position. In the selection area 1802, as candidates for the reference tag, the user IDs and the user names are displayed as a list in a selectable manner. The user selects the reference tag via a radio button. In the present embodiment, in the parameter 1803, a radius p and a height h are displayed as authentication area parameters in an imputable manner. In the legend 1804, a schematic view of an authentication area for explaining each parameter of the authentication area parameters is displayed, and in this example, it is a cylinder. When the set button 1805 is operated, setting of the authentication area is performed using the contents set as in the parameter 1803 and the like. When the cancel button 1806 is operated, the screen returns to the screen before the transition without setting the authentication area. Other operations of S701 are as described in the first embodiment.

In S706, the CPU 304 acquires the authentication area information. For example, in the example of the present embodiment described here, as the authentication area parameters, radius p: 50 cm and height h: 150 cm are input.

The authentication area parameters may be considered as various items relating to the shape of the authentication area 110. For example, in the present embodiment, the authentication area 110 is a cylinder. The radius p is the radius of the cylinder, and the height h is the value of the Z component. A method for acquiring a formula representing a cylinder that is parallel with the Z-axis and has a radius p using any point as a reference via a known mathematical method is widely known. Also, a method for acquiring a formula for restricting a cylinder in a range of the height h using any point as a reference via a known mathematical method is generally known. Accordingly, it is clear that, from the spatial coordinates TP of the tag 104, the radius p, and the height h, a formula representing the spatial region of the authentication area 110 can be acquired. FIG. 19 illustrates the positional relationship of the spatial coordinates TP of the tag 104, the radius p, and the height h.

In S707, the CPU 304 stores the spatial coordinates TP of the tag 104, the radius p, and the height h in the storing unit 301 as the authentication area information. After the authentication area information is stored, the tag used in the reference position is no longer required. In other words, from S707 onward, moving the tag 104 does not affect the setting of the authentication area 110.

Next, parts that are different from the first embodiment described above in the flowchart of FIG. 17 will mainly be described. In S802, the CPU 304 determines whether or not the tag (hereinafter referred to as the detected tag) storing the user ID information included in the tag information from all of the anchors 103A to 103D exists in the authentication area 110. In a case where at least one tag exist in the authentication area 110, the process advances to S803. Otherwise, the process advances to S804. A computation method for determining whether or not any point exists in a predetermined spatial region via a known mathematical method is generally known. Thus, computation for determining whether or not a detected tag exists in the authentication area 110 will not be described. The information of the authentication area 110 is stored in the storing unit 301 in S707 as described above. The shape of the authentication area 110 may be one of various plausible shapes. However, in the present embodiment, the storing unit 301 stores the spatial coordinates TP as the reference point, the radius p, and the height h. The inside of the region of the cylinder acquired from these values corresponds to the authentication area 110. A method for acquiring a formula representing a cylinder in the space from the center of the bottom surface, the radius, and the height via a known mathematical method is widely known. Thus, a detailed method of acquiring a formula representing a cylinder in space from the spatial coordinates TP, the radius p, and the height h will not be described. FIG. 19 illustrates the relationship between the spatial coordinates TP of the tag 104 and the authentication parameters. In a case where a plurality of detected tags exist, the determination is performed for all of the detected tags.

As described above, the information processing apparatus according to the present embodiment receives selection information for selection of a wireless terminal to be used in setting the authentication area from the one or more wireless terminals and parameters relating to the authentication area such as radius and height. Also, the present information processing apparatus sets the authentication area on the basis of the spatial position of the wireless terminal corresponding to the selection information according to the received parameters. In this manner, according to the present embodiment, the authentication area is set as a cylinder. Accordingly, the parameters input by the user can be reduced to two parameters relating to the authentication area, namely the radius and the height.

### Third Embodiment

The third embodiment of the present disclosure will be described below. The goal of the present embodiment is that, after the authentication area 110 is set, even if the image forming apparatus 101 is moved or rotated, the relative positional relationship between the authentication area 110 and the image forming apparatus 101 is maintained in association without re-setting the authentication area 110. In the first embodiment described above, the authentication area 110 is set without taking into consideration the position of the image forming apparatus 101. Thus, after the authentication area 110 is set, if the image forming apparatus 101 is moved or rotated, the relative positional relationship between the authentication area 110 and the image forming apparatus 101 is changed, making re-setting necessary. In the present embodiment, mainly the configurations and controls that are different from the first embodiment will be described.

The image forming apparatus 101 according to the present embodiment includes an apparatus tag (not illustrated) inside the image forming apparatus 101. The apparatus tag is preferably disposed in the center of the image forming apparatus 101. For example, in the present embodiment described here, the tag information stored in the apparatus tag inside the image forming apparatus 101 is user ID: ID9 and user name: Apparatus 1.

In addition to the authentication area information and the spatial coordinates of the anchors 103A to 103D, the storing unit 301 of the determination unit 102 also stores front direction information of the image forming apparatus 101. The front direction information of the image forming apparatus 101 is input by the user when the installation state of the image forming apparatus 101 is changed, that is, when the image forming apparatus 101 is moved or rotated. Note that in a case where the image forming apparatus 101 can detect the position information and orientation information, the information may be automatically input to the determination unit 102. The input value is a unit vector of the front direction of the image forming apparatus 101. For example, consider a case in which the image forming apparatus 101 is installed as in FIG. 1. On the front side of the image forming apparatus 101, “front” is engraved. Thus, the front direction of the image forming apparatus 101 corresponds to the front direction in the X-axis. In this case, as the front direction information of the image forming apparatus 101, the user inputs a unit vector (1, 0, 0) of the X-axis direction from the operation unit 302.

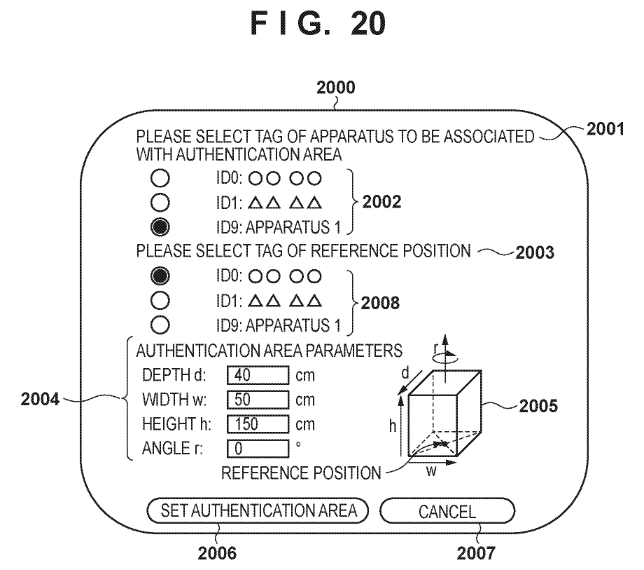

Next, parts that are different from the first embodiment described above in the flowchart of FIG. 13 will mainly be described. In S701, a candidate list of apparatus tags provided in the image forming apparatus 101 associated with the authentication area 110, a candidate list of reference tags corresponding to the reference position for setting the authentication area 110, and the authentication area parameter input field are displayed by the CPU 304 on the operation unit 302. FIG. 20 illustrates an example of a display screen displayed on the operation unit 302. A screen 2000 includes messages 2001 and 2003, selection areas 2002 and 2008, a parameter 2004, a legend 2005, a set button 2006, and a cancel button 2007. The message 2001 displays a message prompting for selection of a tag of an apparatus to be associated with the authentication area. The message 2003 displays a message prompting for selection of a tag of the reference position. In the selection area 2002, as candidates for the tag of the apparatus, the user IDs and the user names are displayed as a list in a selectable manner. In the selection area 2008, as candidates for the reference tag, the user IDs and the user names are displayed as a list in a selectable manner. The user selects the apparatus tag and the reference tag via a radio button. Note that as the candidates for the apparatus tag and the reference tag, only those with a user ID received from all of the anchors 103A to 103D are displayed. The method of listing up the candidates for the apparatus tag and the reference tag is similar to the method of listing up the candidates for the reference tag in S701 of the first embodiment. In the parameter 2004, an authentication area parameter is displayed in an imputable manner. The user inputs a value for the authentication area parameter from the operation unit 302. The input value is stored in the memory (not illustrated). In the legend 2005, a schematic view for explaining each parameter of the authentication area parameter is displayed. When the set button 2006 is operated, setting of the authentication area is performed using the contents set as in the parameter 2004 and the like. When the cancel button 2007 is operated, the screen returns to the screen before the transition without setting the authentication area.

In S702, the CPU 304 determines whether or not an authentication area setting instruction has been issued. In a case where an authentication area setting instruction has been issued, the process advances to S704. Otherwise, the process advances to S703. In the present embodiment, to issue an authentication area setting instruction, the authentication area set button needs to be push operated after the operation unit 302 is used to select the apparatus tag and the reference tag and the authentication area parameters are input.

In S704, the CPU 304 acquires the spatial coordinates of the anchors 103A to 103D as installation information from the storing unit 301. The acquiring method is similar to that in S704 of the first embodiment described above. Also, the front direction information of the image forming apparatus 101 is acquired from the storing unit 301. The front direction information of the image forming apparatus 101 is input by the user in advance when the installation state of the image forming apparatus 101 is changed, that is, when the image forming apparatus 101 is moved or rotated.

In S706, the CPU 304 acquires the authentication area information. First, the spatial coordinates of the vertices K1 to K8 of the rectangular prism are acquired. The acquiring method is similar to that in S706 of the first embodiment described above. Next, the CPU 304 acquires the user ID from the tag information of the apparatus tag and further acquires the spatial coordinates of the apparatus tag. The method for acquiring the spatial coordinates of the apparatus tag is similar to the method of acquiring the spatial coordinates of the reference tag in S705.

In S707, the CPU 304 stores in the storing unit 301, as the authentication area information, the coordinates of the vertices K1 to K8, the tag information of the apparatus tag of when acquiring the authentication area information, and the front direction information of the image forming apparatus 101 of when acquiring the authentication area information. The tag information corresponds to the user ID and the spatial coordinates of the tag. After the authentication area information is stored, the reference tag is no longer required. In other words, from S707 onward, moving the reference tag does not affect the setting of the authentication area 110.

Next, parts that are different from the first embodiment described above in the flowchart of FIG. 17 will mainly be described. In S801, the CPU 304 acquires the spatial coordinates of the tag (hereinafter referred to as the detected tag) storing the user ID information included in the tag information from all of the anchors 103A to 103D. In a case where there is a plurality of detected tags, acquiring is performed for all of the detected tags. The acquired results are stored in the memory (not illustrated). The acquiring method is similar to that in S705 of the first embodiment described above. Also, the CPU 304 acquires the spatial coordinates of the tag (apparatus tag) provided inside the image forming apparatus 101 as one of the detected tags.

In S802, the CPU 304 determines whether or not the tag (hereinafter referred to as the detected tag) storing the user ID information included in the tag information from all of the anchors 103A to 103D exists in the authentication area 110. In a case where a plurality of detected tags exist, the determination is performed for all of the detected tags. However, the apparatus tag is excluded from the determination target. In other words, regardless of the spatial coordinates, the apparatus tag is determined to not exist inside the authentication area 110. This is because it is clear that the apparatus tag is not the tag possessed by the user of the image forming apparatus 101. The user ID stored in the tag is referenced when determining the apparatus tag from among the detected tags. The authentication area information stored in the storing unit 301 is reference, and the detected tag storing the same user ID as the user ID of the apparatus tag is determined to be the apparatus tag. In a case where at least one or more detected tags exist inside the authentication area 110, excluding the apparatus tag, the process advances to S803. Otherwise, the process advances to S804. A computation method for determining whether or not any point exists in a predetermined spatial region via a known mathematical method is widely known. Thus, a detailed computation method for determining whether or not a detected tag exists in the authentication area 110 will not be described. The method for acquiring the authentication area 110 will be described below.

Method for Acquiring Authentication Area 110

The method for acquiring the authentication area 110 according to the present embodiment will now be described. In the storing unit 301, as the authentication area information, the coordinates of the vertices K1 to K8, the tag information of the apparatus tag of when acquiring the authentication area information, and the front direction information of the image forming apparatus 101 of when acquiring the authentication area information are stored. As the tag information of the apparatus tag, the user ID and the spatial coordinates of the tag are stored. As the front direction information of the image forming apparatus 101, the unit vector information is stored. Also, in the storing unit 301, the current front direction information of the image forming apparatus 101 is stored.

First, a movement amount SPT of the apparatus tag is acquired from spatial coordinates SP1 of the apparatus tag of when acquiring the authentication area information and current spatial coordinates SP2 of the apparatus tag. The spatial coordinates SP1 of the apparatus tag of when acquiring the authentication area information is stored in the storing unit 301 in S707. Also, the current spatial coordinates SP2 of the apparatus tag are acquired in S801. If the SPT XYZ components of the spatial coordinates of SP1 and SP2 are: SP1: (SP1X, SP1Y, SP1Z), SP2: (SP2X, SP2Y, SP2Z), and SPT: (SPTX, SPTY, SPTZ), then SPTX = SP2X - SP1X, SPTY = SP2Y - SP1Y, and SPTZ = SP2Z - SP1Z.

SP1X, SP1Y, SP1Z, SP2X, SP2Y, and SP2Z are known values. Thus, SPTX, SPTY, and SPTZ are also known values.

Note that in a case where the image forming apparatus 101 has not moved since when the authentication area information was acquired, SPTX = SPTY = SPTZ = 0.

Next, the movement amount SPT of the apparatus tag is added to the spatial coordinates of the eight vertices K1 to K8 and translation is performed. The translation results in vertices K1’ to K8’. An example of translation of the vertex K1 will now be described.

If the spatial coordinates of vertex K1 are K1: (K1X, K1Y, K1Z), the coordinates of the translated vertex are acquired by adding each SPT component, namely K1’: (K1X + SPTX, K1Y + SPTY, K1Z + SPTZ). K1X, K1Y, K1Z, SPTX, SPTY, and SPTZ are known values. Similar computation as that performed for the vertex K1 is also performed for the vertices K2 to K8, and vertices K2’ to K8’ are acquired.

Also, a rotation angle SPTQ of the image forming apparatus 101 is acquired from front direction information SP1Q of the image forming apparatus 101 of when acquiring the authentication area information and current front direction information SP2Q of the image forming apparatus 101. The SP1Q is stored in the storing unit 301 in S707. Also, the SP2Q is stored in the storing unit 301. For the SP2Q, the user inputs a value when the front direction of the image forming apparatus 101 changes after the authentication area information has been acquired. In a case where the front direction of the image forming apparatus 101 has not changed after the authentication area information has been acquired, the SP2Q and the SP1Q are the same value. The SP1Q and the SP2Q are vectors. A method for acquiring the angle formed by the two vectors via a known mathematical method is widely known. Thus, a detailed description of acquiring the angle SPTQ formed by the SP1Q and the SP2Q will be omitted.

Note that in a case where the image forming apparatus 101 has not rotated since when the authentication area information was acquired, SPTQ = 0°.

The coordinates of the vertices K1’ to K8’ are rotated the angle SPTQ about a line parallel with the Z-axis running through the point SP2. The vertices after rotation of the vertices K1’ to K8’ correspond to K1’’ to K8’’. A method for acquiring the spatial coordinates of a point acquired by rotating any point any angle about any line via a known mathematical method is widely known. Thus, a detailed description of acquiring the vertices K1’’ to K8’’ from the vertices K1’ to K8’ will be omitted. The inside of the rectangular prism formed with the eight points corresponding to the acquired eight vertices K1’’ to K8’’ as the vertices corresponds to the authentication area 110.

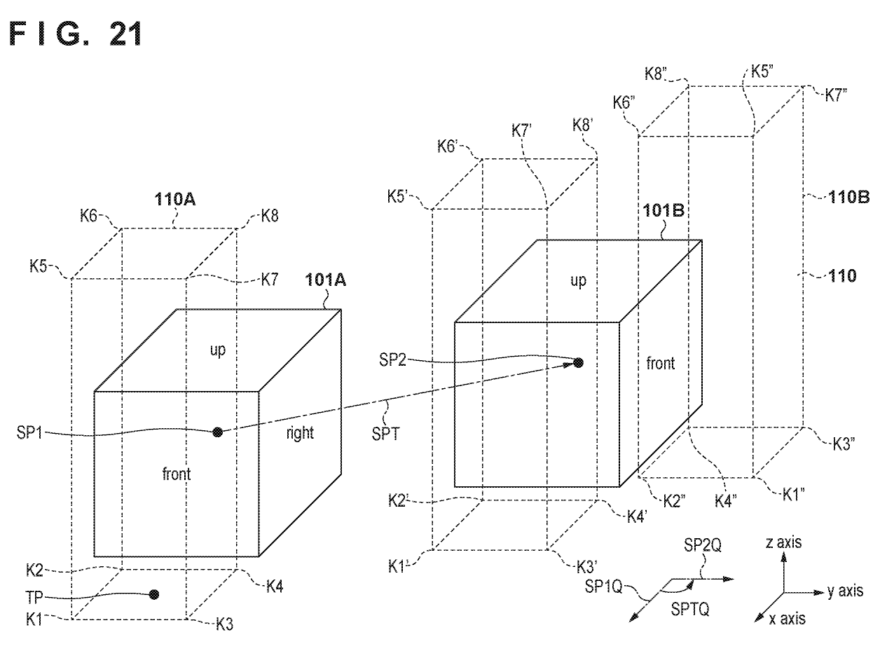

FIG. 21 illustrates the positional relationship of the computation described above. On the front of the image forming apparatus 101 “front” is engraved, on the upper surface, “up” is engraved, on the right side as seen from the front, “right” is engraved. FIG. 21 illustrates the image forming apparatus 101 installed at a position 101A at the time of acquiring the authentication area information in S706 having been moved to a position 101B thereafter. It also illustrates the image forming apparatus 101 having been arranged with the SP1Q direction as the front side being changed to an arrangement with the SP2Q direction as the front side due to the image forming apparatus 101 being moved. The apparatus tag is provided at the center of the image forming apparatus 101. Also illustrated is that the apparatus tag has moved from the SP1 position to the SP2 position due to the image forming apparatus 101 being moved. Also illustrated is that an authentication area 110A defined as the inside of the rectangular prism with the points K1 to K8 as the vertices has been moved to an authentication area 110B defined as the inside of the rectangular prism with the points K1’’ to K8’’ as the vertices due to the image forming apparatus 101 being moved. The points K1’ to K8’ indicate points temporarily acquired when the spatial coordinates of points K1’’ to K8’’ are acquired from points K1 to K8. In other words, the authentication area according to the present embodiment is set in association with the relative positional relationship with the image forming apparatus (apparatus tag).

In S803, the CPU 304 transmits the user information to the image forming apparatus 101. Specifically, the user ID and the user name stored in the detected tag determined to exist in the authentication area 110 in S802 are transmitted by the CPU 304. In a case where there are a plurality of target tags existing, information for all of the tags corresponding to targets is transmitted. Note that the apparatus tag is determined to not exist inside the authentication area 110 in S802. Thus, the user ID and the user name are not transmitted to the image forming apparatus 101.

As described above, the image forming apparatus according to the present embodiment is provided with an apparatus tag, which is a wireless terminal. Also, the present information processing apparatus acquires spatial position information of the apparatus tag in addition to that of a wireless terminal detected by a plurality of anchors. The present information processing apparatus sets an authentication area using the spatial position information of the wireless terminal (reference tag) acquired from each anchor and the apparatus tag and information of the installation position of each one of the plurality of anchors and the front direction information of the image forming apparatus. Accordingly, after the authentication area information is acquired in S706, even if the image forming apparatus 101 is moved or rotated, the relative positional relation of the authentication area 110 and the image forming apparatus 101 can be maintained without re-setting the authentication area 110.

### Fourth Embodiment

The fourth embodiment of the present disclosure will be described below. In the present embodiment, a configuration in which the image forming apparatus 101 and the determination unit 102 are integrally formed will be described. Also, in the present embodiment, a configuration in which the anchors 103A to 103D are provided inside the image forming apparatus 101 will be described. Note that in a configuration in which the image forming apparatus 101 and the determination unit 102 are integrally formed, the anchors 103A to 103D may be provided outside of the image forming apparatus 101. In the present embodiment, after the authentication area 110 is set, even if the image forming apparatus 101 is moved or rotated, the relative positional relationship between the authentication area 110 and the image forming apparatus 101 can be maintained without re-setting the authentication area 110. In the first embodiment described above, the authentication area 110 is set without taking into consideration the position of the image forming apparatus 101. Thus, after the authentication area 110 is set, if the image forming apparatus 101 is moved or rotated, the relative positional relationship between the authentication area 110 and the image forming apparatus 101 is changed, making re-setting necessary. In the present embodiment, mainly the configurations and controls that are different from the first embodiment will be described.

In the present embodiment, the determination unit 102 and the anchors 103A to 103D are provided inside the image forming apparatus 101. The image forming apparatus 101 is designed dimension-wise so that the positions of the anchors 103A to 103D provided inside are fixed.

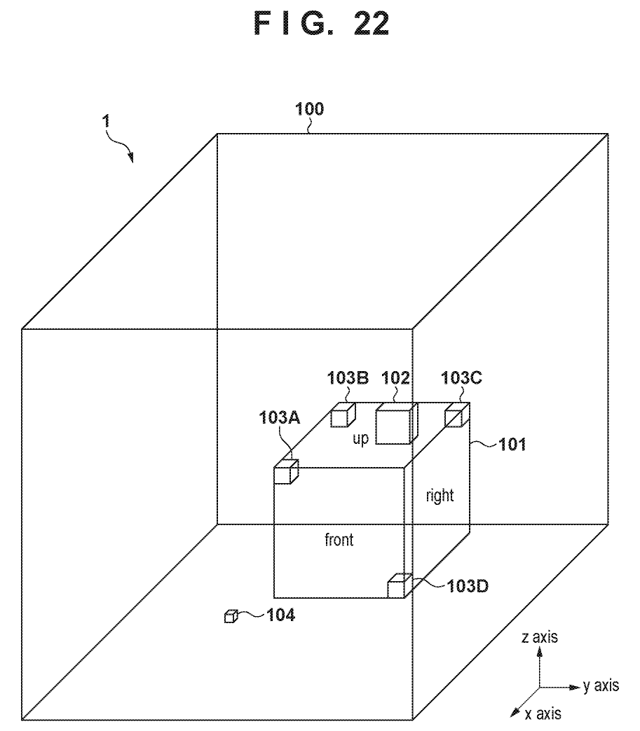

FIG. 22 is an overhead view of the entire image forming system 1 according to the present embodiment. As illustrated, the image forming apparatus 101, the determination unit 102, the anchors 103A to 103D, and the tag 104 are disposed inside the predetermined space 100. The determination unit 102 and the anchors 103A to 103D are provided inside the image forming apparatus 101.

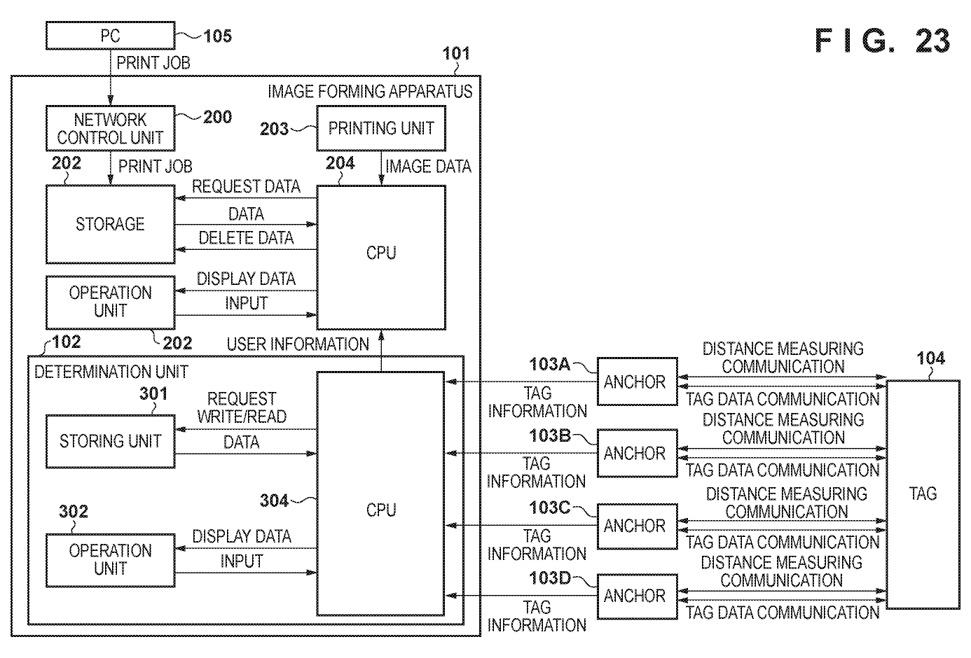

FIG. 23 is a block diagram of the entire image forming system 1 according to the present embodiment. The image forming apparatus 101 includes the network control unit 200, the storage 201, the operation unit 202, the printing unit 203, and the CPU 204. The network control unit 200, for example, uses a wired or wireless local area network (LAN) interface. Print job data received from the external PC 105 is stored in the storage 201. The print job data includes the user ID of the user who transmitted the print job, a print image, and print operation settings. The storage 201, for example, uses a hard disk drive (HDD). The print job data input from the network control unit 200 is stored. Also, the stored print job data is transmitted to the CPU 204 in response to a request from the CPU 204. Furthermore, the print job data is deleted in response to a deletion request from the CPU 204. The operation unit 202, for example, uses a liquid crystal touch panel. A screen is displayed according to display data input from the CPU 204. Also, the input by a user on the touch panel is transmitted to the CPU 204. The printing unit 203 is a control unit for printing image data on a sheet. The printing unit 203, for example, uses a print control unit of a laser beam printer using a known typical electro-photographic method. An image is printed on a sheet held in a sheet holding unit (not illustrated) according to image data received from the CPU 204. The sheet where an image is printed on is discharged outside of the image forming apparatus 101 so as to be acquired by the user of the image forming apparatus 101. The CPU 204 performs control of the entire image forming apparatus 101 excluding the determination unit 102. The storage 201 is requested for the print job data, and the print job data is acquired. Also, in a case where print job data is not required, a print job data deletion request is performed. Screen display data for communicating information to the user is transmitted to the operation unit 202. Also, the content input on the touch panel by the user is received. The user information is received from the determination unit 102. The user information is used in selecting a print job to be acquired from the storage 201 and the like.

The determination unit 102 includes the storing unit 301, the operation unit 302, and the CPU 304. The storing unit 301, for example, uses a hard disk drive (HDD). The storing unit 301 writes data in response to a write request from the CPU 304. Also, the storing unit 301 transmits stored data to the CPU 304 in response to a read request from the CPU 304. The storing unit 301 stores authentication area information and the spatial coordinates of the anchors 103A to 103D. The operation unit 302, for example, uses a liquid crystal touch panel. The operation unit 302 displays a screen according to display data input from the CPU 304. Also, the operation unit 302 transmits input by a user on the touch panel to the CPU 304.

The CPU 304 controls the entire determination unit 102. The CPU 304 reads and writes data to and from the storing unit 301. The CPU 304 transmits, to the operation unit 302, screen display data for communicating information to the user and receives user input on the touch panel. The CPU 304 receives tag information from the anchors 103A to 103D. The CPU 304 transmits user information acquired from the tag information to the CPU 204 of the image forming apparatus 101. The operations of the anchors 103A to 103D and the tag 104 are similar to that in the first embodiment.

Parts that are different from the first embodiment described above in the flowchart of FIG. 13 will mainly be described. In S704, the CPU 304 acquires the spatial coordinates of the anchors 103A to 103D from the storing unit 301. The spatial coordinates of each anchor is input in advance to the storing unit 301 at the time that the image forming apparatus 101 is manufactured. The spatial coordinates of each anchor will now be described. For example, as illustrated in FIG. 22, in the present embodiment, the spatial coordinates of each anchor are stored, where the direction perpendicular to the front surface of the image forming apparatus 101 is the X-axis direction, the direction perpendicular to the right surface as seen from the front surface is the Y-axis direction, and the direction perpendicular to the upper surface is the Z-axis direction. Also, the reference point of the spatial coordinates is the position of the anchor 103A disposed inside the image forming apparatus 101. Here, the spatial coordinates of each anchor are spatial coordinates AP: (AX, AY, AZ) for the anchor 103A, spatial coordinates BP: (BX, BY, BZ) for the anchor 103B, spatial coordinates CP: (CX, CY, CZ) for the anchor 103C, and spatial coordinates DP: (DX, DY, DZ) for the anchor 103D. Note that the spatial coordinates of each anchor indicate the spatial coordinates of the center of each anchor. At this time, AP is the reference point, and thus AX, AY, AZ = 0. BX, BY, BZ, CX, CY, CZ, DX, DY, and DZ are values that can be acquired from the arrangement dimensions of the image forming apparatus 101 and thus are known values.

As described above, the present information processing apparatus (determination unit 102) may be integrally formed with the image forming apparatus 101. Also, the anchors 103A to 103D may also be provided inside the image forming apparatus 101. Accordingly, in the present embodiment, the spatial coordinates of the anchors 103A to 103D can be easily acquired from the design dimensions of the image forming apparatus 101 without the user measuring. Also, the authentication area 110 is defined on the basis of the spatial coordinates of the anchors 103A to 103D inside the image forming apparatus 101. Thus, after the authentication area 110 is set, even if the image forming apparatus 101 is moved or rotated, the spatial coordinates of each anchor are tracked and moved or rotated. Accordingly, the relative position between the authentication area 110 and the image forming apparatus 101 can be maintained without re-setting the authentication area 110.

### Modification Example

The present disclosure is not limited to the embodiments described above and can include various modifications. In the embodiments described above, an image forming apparatus is used as an apparatus using an authentication area. However, the present disclosure can be applied to a different apparatus. For example, it may be applied to a touchless payment system in which a user possessing a wireless terminal is detected staying in an authentication area and data communication is performed with the wireless terminal to execute account settlement processing.

Also, in the embodiments described above, the authentication area parameter items input from the operation unit can be changed according to the shape of the authentication area to be generated. The present disclosure can be applied even in the case of a change.

Also, in the embodiments described above, by measuring the distance between the anchors and the tag, the spatial coordinates of the tag is acquired. However, the present disclosure can be applied in the case of another method being used as long as the spatial coordinates of the tag can be acquired. A plausible method includes measuring the angle of the tag with respect to the anchors. From the result of measuring the angle of the tag from the plurality of anchors disposed at different positions, the spatial coordinates of the tag may be acquired.

Also, in the embodiments described above, as the anchors and the tag device, ultra-wideband (UWB) wireless communication devices are used. However, the present disclosure can be applied in a case where other devices with a similar function are used. For example a positioning system using known Bluetooth Low Energy (BLE) may be used. However, the since the tag detection range of the anchor and the distance measurement accuracy is greatly dependent on the device, an appropriate device needs to be selected depending on the application.

Also, in the embodiments described above, the number of anchors is four. However, the present disclosure can be applied in a case where the number of anchors is more or less as long as the spatial coordinates of the tag can be acquired. For example, in a case where the anchors have a function of being able to detect the three-dimensional direction of the tag, two anchors can identify the spatial coordinates of the tag.

In the third embodiment described above, the user inputs the orientation of the image forming apparatus. However, the present disclosure can be applied to the case of an automatic acquiring method. For example, a geomagnetic sensor may be provided in the image forming apparatus, and a method in which the determination unit acquires the value of the geomagnetic sensor may be used.

According to the present disclosure, for example, a mechanism for suitably setting a predetermined spatial region and providing a service can be provided.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-200020, filed November 15, 2024, hereby incorporated by reference herein in its entirety.

What is claimed is:

1. An information processing apparatus that sets an authentication area for providing a service, comprising:
one or more memory devices that store a set of instructions; and
one or more processors that execute the set of instructions to:
acquire, from a plurality of detection units that are installed at different positions and detect one or more wireless terminals located in a detectable range, spatial position information of the one or more wireless terminals detected, and
set the authentication area using the spatial position information relating to one wireless terminal acquired from each detection unit and information of an installation position of each one of the plurality of detection units.

2. The information processing apparatus according to claim 1, further comprising:
four detection units as the plurality of detection units,
wherein the one or more processors execute instructions in the one or more memory devices to:
acquire, from the four detection units, a distance between each one of the four detection units and the one or more wireless terminals as spatial position information of the one or more wireless terminals, and
determine a spatial position of the one or more wireless terminals from the distance between each one of the four detection units and the one or more wireless terminals.

3. The information processing apparatus according to claim 2, wherein
user input is received of selection information for selecting a wireless terminal to be used in setting the authentication area from the one or more wireless terminal and a parameter relating to the authentication area, and the authentication area is set based on a spatial position of the wireless terminal corresponding to the selection information according to a received parameter.

4. The information processing apparatus according to claim 3, wherein
the parameter includes depth, width, and height parameters relating to the authentication area, and
the authentication area to be set is a rectangular prism.

5. The information processing apparatus according to claim 4, wherein
the parameter further includes a rotation angle parameter relating to the authentication area, and
the authentication area to be set is set with orientation, based on the rotation angle.

6. The information processing apparatus according to claim 3, wherein
the parameter includes radius and height parameters relating to the authentication area, and
the authentication area to be set is a cylinder.

7. The information processing apparatus according to claim 2, wherein
the four detection units are disposed in a spatial region in a proximity of an apparatus that provides the service, with three detection units being disposed on a predetermined surface and one detection unit being disposed on a surface different from the predetermined surface.

8. The information processing apparatus according to claim 7, wherein
the four detection units are disposed in a spatial region of a rectangular parallelepiped in a proximity of an apparatus that provides the service, with three detection units being disposed at vertices of a predetermined surface of the rectangular parallelepiped and one detection unit being disposed at a vertex of a surface that is opposite the predetermined surface corresponding to a vertex, from among the vertices of the predetermined surface, where a detection unit is not disposed.

9. The information processing apparatus according to claim 1, wherein
the plurality of detection units are provided inside or outside an apparatus that provides the service.

10. The information processing apparatus according to claim 9, wherein
the apparatus that provides the service is provided with an apparatus tag which is a wireless terminal, and
the one or more processors execute instructions in the one or more memory devices to:
acquire spatial position information of the apparatus tag in addition to that of the wireless terminal detected by a plurality of detection units, and
set the authentication area using the spatial position information of the wireless terminal acquired from each detection unit and the apparatus tag and information of an installation position of each one of the plurality of detection units and front direction information of the apparatus that provides the service.

11. The information processing apparatus according to claim 10, wherein
the one or more processors execute instructions in the one or more memory devices to:
set the authentication area in association with a relative positional relationship with the apparatus that provides the service.

12. The information processing apparatus according to claim 9, wherein
the information processing apparatus includes an update mode and a maintain mode as operation modes,
in the update mode, the acquired information is stored in a storage unit, and
in the maintain mode, the acquired information is read out from the storage unit and setting of the authentication area is performed.

13. The information processing apparatus according to claim 9, wherein the one or more processors execute instructions in the one or more memory devices to
perform authentication by determining whether or not a wireless terminal associated with a user requesting the service exists in the authentication area using the plurality of detection units, and
allow the service to be provided in a case where authentication is successful.

14. The information processing apparatus according to claim 13, wherein
the apparatus that provides the service is an image forming apparatus that provides image forming.

15. An image forming apparatus, comprising:
the information processing apparatus according to claim 13; and
an image forming unit.

16. A control method for an information processing apparatus that sets an authentication area for providing a service, comprising:
acquiring, from a plurality of detection units that are installed at different positions and detect one or more wireless terminals located in a detectable range, spatial position information of the one or more wireless terminals detected; and
setting the authentication area using the spatial position information relating to one wireless terminal acquired from each detection unit and information of an installation position of each one of the plurality of detection units.

17. A non-transitory storage medium storing a program for causing a computer to execute a control method for an information processing apparatus that sets an authentication area for providing a service, the control method comprising:
acquiring, from a plurality of detection units that are installed at different positions and detect one or more wireless terminals located in a detectable range, spatial position information of the one or more wireless terminals detected; and
setting the authentication area using the spatial position information relating to one wireless terminal acquired from each detection unit and information of an installation position of each one of the plurality of detection units.
